(19) United States
(12) Patent Application Publication
(10) Pub. No.: US 2014/0019457 A1
(43) Pub. Date: Jan. 16, 2014

(54) SYSTEM AND METHOD FOR INDEXING, RANKING, AND ANALYZING WEB ACTIVITY WITHIN AN EVENT DRIVEN ARCHITECTURE

(71) Applicant: Wanxia XIE, East Brunswick, NJ (US)

(72) Inventor: Wanxia XIE, East Brunswick, NJ (US)

(21) Appl. No.: 13/939,616

(22) Filed: Jul. 11, 2013

Related U.S. Application Data
(60) Provisional application No. 61/670,481, filed on Jul. 11, 2012.

(51) Int. Cl. G06F 17/30

(52) U.S. Cl. CPC G06F 17/30321
USPC 707/741

(57) ABSTRACT

Disclosed is a system for organizing a web activity including a parsing module for receiving the web activity, a concept indexing module for indexing the web activity according to a plurality of concepts in a concept index, a web event creation module for generating a plurality of web events from the web activity, a web activity indexing module for indexing the web activity according to the plurality of web events in a web event index, a ticker management module for generating a plurality of tickers each respectively associated with at least one of the plurality of concepts, and a database for storing the concept index, the web event index, and the plurality of tickers.

### CROSS REFERENCE TO PRIORITY/PROVISIONAL APPLICATION

This application claims benefit to the filing date of U.S. Provisional Application No. 61/670,481 filed Jul. 11, 2012, the entirety of which is hereby incorporated by reference.

### BACKGROUND OF THE INVENTION

1. Field of the Invention

The embodiments of the invention relate to a system and method for analyzing content on the World Wide Web and more particularly, to a system and method for indexing and ranking World Wide Web content. Although embodiments of the invention are suitable for a wide scope of applications, it is particularly suitable for incorporating traditional published World Wide Web content with new-media content such as mobile applications, social media, crowd sourced media, and blogs.

2. Discussion of the Related Art

In general, the problem for users to efficiently navigate, discover, filter, and participate in the web has been a challenge since the development of the web browser. Finding timely and relevant information in an efficient manner is the goal of all web users. This is especially challenging given the changing dynamics of what constitutes content and the changing definitions of a content source. There has been a transition from online content being published predominantly on websites by web publishers to online content being published via blogs, microblogs, videos, images, comments, user reviews, and social networks. Increasingly, content and activities are being generated through mobile devices. Examples of content on social networks include status updates, tweets, re-tweets, weibos, and user actions such as likes, check-ins, bookmarks, pins, and favorites.

The predominant model over the past decade that web users have utilized to navigate the web is the search engine model. Current implementations rely on numerous tactics to provide relevant content to users, but the most significant driver of relevance is inbound links (See, e.g. U.S. Pat. No. 6,285,999 to Page) and keyword indexing. These approaches worked well because they captured predominant human activity on the web at that time: linking to other sites and click-throughs. The result is a crowd-sourcing relevance determination that is in essence a popularity contest. However, the strength of this model is also its greatest weakness, which is the heavy focus on web pages and text-based content. With new forms of content and measures of online influence getting popularized, such an approach is no longer adequate because it does not capture this new information. With the immense growth in human actions and activity, as described above, inbound links and click-throughs are too simplistic to account for the new complexities of web activity. The result is that a significant amount of valuable, timely information is lost, causing frustrations and inefficiencies for online users.

For example, search engines today do not support a framework to capture user actions, participants, the flow of information across users, and other types of web activity (other than click-throughs and links). In addition, search engines have a historical bias given their measure of influence being a popularity contest based on inbound links. In this model, for a compelling website to gain significant number of inbound links, especially within a popular search keyword, a significant amount of time is required to attain those links. In this manner, current implementations of search engines are backward-looking and therefore optimal to determine past relevance, but not optimal for determining relevance for new and fresh content that still is not necessarily popular.

Problems also arise when the same content appears in multiple sources, which is often the case. Some sources may be updated frequently, while other sources may not be updated at all. When the information is updated at one source first, the latest and accurate information is in the minority. The crowd-sourcing approach could rank the old and stale information higher as it is agreed by the majority of other sources. The information updates over the sources indicate the implicit actions at the background. Monitoring the information update behavior over the sources can be used to analyze and rank the new and accurate information. However, current implementations of search engines and analysis tools ignore these implicit actions and missed the important signals to rank and analyze the results.

In addition, the content of static and dynamic web pages is updated over time. The content change over time is ignored by current systems as only one of the snapshots of such content is used. Online content is no longer neatly packaged within web pages or defined solely in text form. Therefore, technologies such as search engines, which have been successful in helping users find relevant online content, are no longer optimal given their focus on web page links and text-based, keyword indexing.

Recent technologies such as social networking, blogs, micro-blogging, and user-based action systems have transformed the Internet and Mobile Internet from a web of text-based documents to a web of actions and activity. Examples of action-based systems that create this new type of content include curation applications like Digg, social bookmarking sites like Delicious and Pinterest, re-tweet applications like Tweetmeme, sharing platforms like Twitter, Weibo and Tumblr, comments systems like Disqus and Echo, check-in systems via location-based applications like FourSquare, and many others. The amount of human actions and activity on the web (and in mobile devices) has increased tremendously due to such new recent technologies. Compared to the explicit user actions in the above technologies, content changes in the web pages (or applications etc) over the time indicate the implicit user actions at the background. By monitoring the content changes, these actions could be captured into the system for intelligence analysis.

There has also been a greater emphasis on user identity over recent years. Twitter, a micro-blogging platform, has built a community around public user-profiles and micro-messages. Disqus and Echo are commenting systems that enable a user to have a single identity (that includes the user's name and optional photo) across thousands of blogs for their comments. A number of web applications have begun to measure and score a user's online influence based on traffic on their blog and number of followers in Twitter, LinkedIn, and other social networks. So while just a few years ago, the currency of online influence was measured by the number of unique visitors to a website and inbound links, now the measure of online influence also needs to account for users' online influence.

Emerging technologies around a field called real-time search have attempted to address this limitation with current search engine approaches. In general, these technologies have attempted to focus on links that are popular, measured by how often they are shared or re-shared by users in social networks. This methodology helps in addressing issue of immediate relevance, but is still lacking in providing a complete perspective and measurement of relevance around topics, the participants within those topics, the changing relationships between people or people and content within those topics, the type of activity occurring within those topics, among other things. The focus on popularity still creates a backward-looking bias. In addition, these systems are only capturing a small subset of online activity mainly by focusing on a platform that makes this data readily available (i.e., Twitter). These systems are effectively using a dated approach with some minor tweaks instead of an approach that truly captures the new disruptive complexities of the web around online content (both web documents and action-based content), online participants, and web activity.

The result is that neither traditional web-based search nor real-time search provides users with sufficient visibility into the web given their implementations are too simplistic to reflect the recent complexities and increase in types of human actions and activity. Neither implementation provides their users with data or insights on the web participants who are influential within specific keywords or topics. Instead, each focuses on links to web content as opposed to highlighting the new content: the people who are creating much of the online content in the new web. Neither implementation tells its users where on the web there are active and timely conversations around topics of interest to the user, even though these conversations represent a rich source of online content. Instead, both implementations output a black box list of links based on unknown algorithms. Current implementations do not connect the dots in a manner that offers users a sufficient compass to efficiently navigate, discover, and participate actively in the web. The result is less visibility into the web and frustration for users since they are relegated as historians having to get a snapshot of the web in the past.

Current implementations of social networks do offer a compelling tool around people and web participants who create the content. In this framework, users can curate content over the web via recommendations from other users in their social graph. But current implementations of social networks only provide this one aspect of online content, and they are limited to their walled garden. For example, if a user searches on Twitter, it is not equivalent to searching the web. It is only a small subset of information. For example, conversations and social interactions within a blog would not be captured by a social network. And if users only rely on their social networks to curate the web, they would have a myopic lens due to the limitations of the size of their network. With a focus primarily on web participants, current implementations come out on the opposite side of the continuum of search technologies. Their model is too user-centric and lacking in a framework to intelligently merge their user content with other online web content.

The result is a divided web: the camp that specializes in managing and indexing content and the camp that specializes in managing social graphs. The problem is neither captures the complexities and interrelations among users, websites, actions, and content (raw and indexed content). Users are left with a best-efforts process in using both approaches separately to curate the web. The issue is that neither is optimal, resulting in frustration for users in terms of time, information overload, and inefficiencies.

### SUMMARY OF THE INVENTION

Exemplary embodiments of the present invention create an architectural transformation and eliminate one or more of the problems described above. The present invention not only eliminates one or more of these problems, but also provides a framework to predict relevance so users can discover critical information sooner and participate earlier in web conversations.

Embodiments of the present invention can contain a number of processes, modules, or subsystems, including: a real-time crawling and aggregation subsystem, a feed processing subsystem, a parsing subsystem, a social graph analytics subsystem, a Concepts Indexing subsystem, an activity indexing subsystem, a semantic subsystem, a sentiment subsystem, a classification subsystem, an influencer ranking subsystem, a Web Event creation subsystem, a Web Activity bundling and management subsystem, a Ticker management and creation subsystem, a Ticker enrichment subsystem, a Web Activity and Web Event ranking subsystem, a Web Activity and Web Event description generation subsystem, a web stream management subsystem, a system for data storage, a developer configuration and management subsystem, an event-routing distribution subsystem, a rules-based event subsystem for filtering, a complex event-processing module or subsystem to correlate, analyze, and predict events, an authentication subsystem, a web or mobile application, an appliance that enables proprietary web indexing, and an API.

Embodiments of the present invention can aggregate and index Web Activity. Web Activity can include public web content and private web content such as private feeds in social networks like Facebook or Twitter or Weibo. Web Activity can also include implicit human actions derived by monitoring the update of these web content over time and any internet or mobile activities and actions by humans or applications. Web Activity can further include public or internal data records such as documents, emails and instant messages, derived activity and properties using proprietary or third-party analytics and algorithms, activity obtained from a third-party API, explicit and implicit activity and changes within users' social graphs, content, tags, and metadata.

Examples of Web Activity can include status updates, tweets, re-tweets, weibos, comments, check-ins, favorites, likes, dislikes, shares, pins, new concepts and topics, new web participants, downloads of applications from app stores for mobile phones and social networks, activity level of concepts, changes in activity levels for a concept, changes in activity level by web participants, actions by new participants within a concept, repeat actions by participants within a concept, users' online influence within a concept, changes of users' online influence within a concept, users' sentiment towards a concept, changes of users' sentiment towards a concept, flow of information across websites, flow of information across web participants, geographic location of content, location of content on web, location of content on a web page, content type (including, but not limited to, blogs, image, video, comment, and status update), content quality and classification (for example, spam or authoritative, language), path of information over time, relative time of web actions by participants, click-through rates, changes in structure of users' explicit social graphs, changes in structure of users' implicit social graphs as defined by how users engage with other users in web conversations, changes in users' social profiles, changes in concepts and topics referenced by a user or by users' social graph, web metadata, user metadata, concept metadata, content sentiment, trends of a concept, deltas of any web activity, and new relationships between content and web participants.

Embodiments of the present invention can monitor the updates of web content for a certain source over time and derive the implicit human actions. For example, the contact information of a business or a person could appear on multiple sources and be updated differently at these multiple sources. Embodiments of the present invention can combine machine learning and clustering techniques with analysis of the updating activities of different sources to decide the authoritative information from multiple sources and discover the hidden pattern.

Embodiments of the present invention can monitor online content and activity to identify and record concepts on the web through a process called Concept Indexing. Concepts can be any set of keywords that appear on the web and, as defined by the present invention, represent a unique topic. These topics can be self-organized to reflect changes in online content as opposed to a top-down driven taxonomy, although either mechanism can be utilized by the invention. Examples of a concept can be “swine flu”, “real time search”, “Barrack Obama”, and “Microsoft Yahoo acquisition”. There is no limit to the number of words in a topic. The invention can apply semantic, clustering, and fuzzy matching techniques to extract topics and account for keyword synonyms and semantic meaning. This can enable keywords such as “buy”, “acquire”, or “merge” to be lumped into a single topic such that a concept better reflects meaning as opposed to be limited by specific keywords.

Concept Indexing can enable vastly different capabilities versus keyword indexing since by enabling web users to follow a concept over time, in a similar manner, for example, as users currently follow other users in social networks like Twitter or Weibo. For example, when following a concept a user can view the timely flow of content related to a concept, all the metadata related to that concept, and all relevant web activity related to that concept. In an exemplary embodiment of the present invention, Web Activity described above can be indexed to a concept. For example, within each concept the embodiments of the present invention can monitor activity levels, sentiment, trends, web participants, and related data sources such as URLs. This allows concepts on the web to be monitored and tracked over time. In one exemplary embodiment, trending topics and keywords specifically within a concept can be provided to users as opposed to alternative solutions that provide broad, highly generalized trends.

The present invention can create a label or “Ticker” for each concept. A Ticker can be equivalent to a programmatic hash-tag, except it can reflect significantly more information than just keywords. For example, a Ticker can also include information for Web Activity. This can allow users and developers to search historical web content or subscribe to future web content using Tickers where the query includes Web Activity in addition to keywords. For example, a user can search for “Swine Flu” but also specify content type (video, image, comments, etc.), content source, authority, sentiment of content, and/or content category (shopping, health, etc.). This can allow users to pinpoint the information desired. In another example, an online travel publisher can subscribe to user reviews for hotels that reflect only a positive sentiment. In such an example implementation, Tickers can function as a query language for web content and Web Activity (both historical and future) as a mechanism for developers to build their own applications. The benefit to programmers is that they do not need to build out the Web Activity indexing and analytics themselves but instead can leverage, via an API in one example embodiment, the functionality of embodiments of the invention.

In an exemplary embodiment of the invention, Tickers are data-enriched using third-party data sources including, but not limited to, human-curated sources such as Wikipedia and Freebase, structured data sources such as Wolfram, and user-defined metadata where users can create private and public content classes and categories. In the user-defined example, users can provide keyword tags and “Web Activity Tags” to instruct the embodiments of the invention how to index Web Activity. The user-defined metadata can be used privately, within an enterprise for example, or be made available publicly.

Embodiments of the invention can contain a configuration and management subsystem for developers or organizations to build applications using Tickers and Web Events. In an exemplary embodiment, the invention can include a Graphical User Interface to allow programmers to easily construct a Ticker and access data from the invention.

In an exemplary embodiment, all Web Activity can be indexed and normalized using a proprietary data model so unique interrelations can be mapped and analyzed. In an exemplary embodiment the data model can create an interrelation between keywords and Concepts and then interrelations among Concepts, Web Participants (e.g., people), Data Records (e.g., URLs or tweet or weibo), properties of each, and derived properties. Derived properties can include Web Events or any analytics on the stored data. An example of calculating and storing derived properties can be how investment banks periodically record and store deltas, gammas, and thetas for options using their own proprietary options pricing models.

The result of the data model can be a unique social graphing of concepts, metadata, and data records (e.g., web links). For example, for every Concept there can be interrelationships to web participants and URLs. Or for every web participant, there can be interrelationships to Concepts and URLs. Lastly, for every URL there can be interrelationships to web participants and Concepts. And since Concepts account for Web Activity, this would go beyond a keyword approach to access information on the web. Instead, the present invention can enable users to query the web by the following exemplary queries: keyword, concept, web participant, data record, metadata, or any combination.

Embodiments of the invention transform indexed Web Activity into Web Events, using for example, an events-processing and monitoring framework and architecture. As an example, a user comment on a blog can be considered a Web Activity. The present invention can monitor and identify several Web Events from this single Web Activity like radar that monitors flight path and altitude of an aircraft. For example, from the single Web Activity of a user comment, the following exemplary Web Events may be monitored and recorded in the invention: a new comment with a blog, a new concept noted from the user's comments, and a new web participant within a concept. In this manner, a basic activity on the web may be broken down into many events that may be recorded and analyzed. The Web Events can contain a timestamp so that a sequential timeline of Web Activity is recorded. Web Events can be stored in a database and, in some instances, simultaneously routed to internal and external subscribing applications and databases. In an exemplary embodiment, a Web Event can be an event in an event-based framework except that each event correlates to a specific type of Web Activity. In an exemplary embodiment of the invention, Web Activity and Web Events can be replayed generally or within a concept so that users can see how events unfolded on the web.

In an exemplary embodiment, a web or mobile application can offer users a dynamic directory of the web where these interrelationships are mapped in real-time. This can provide users with visibility into how the web interrelates in terms of content, people, and web links. Further, the web or mobile application can include a heat-map of activity on the web, in general or around specific concepts.

In an exemplary embodiment, once Web Activity is transformed into Web Events, the events can be intelligently analyzed and correlated. Complex event processing techniques and quantitative algorithms can be applied to the events to predict relevance and future Web Activity. In this exemplary embodiment, the invention can turn activity on the web into quantifiable events that can be analyzed much in the same way as algorithms are applied to algorithmic trading in financial markets or government intelligence for counter-terrorism. In an exemplary embodiment, the invention can correlate the path of information across web participants or across sources or in the time for information to spread across web participants in order to predict, as an example, increasing relevance of new web participants, useful content, or new content sources. In this manner, the embodiments of the invention may be forward-looking as opposed to solely providing historical relevance to users.

In an exemplary embodiment, the invention can bundle Web Activity to form its own intelligent activities and events. The purpose would be to provide users with a unique snapshot of activity on the Internet without overbearing users with too much information. In an exemplary embodiment, the invention can bundle activities and events within concepts so users could quickly grasp intelligence and activity around a topic. In another exemplary embodiment, the invention can bundle activities and events generally. Examples of intelligence can include recommendations (around content, sources, web participants, and new Tickers), predictions, highlighting new concepts for discovery, alerting users when there are standard deviation changes in activity levels of concepts or a web participant's activity, suggestions of web participants that a user should follow in their social networks given the influence of that web participant around similarly interested concepts, suggestions of URLs where there is a lot of web activity, suggestions based on subscriptions of users, suggestions based on implicit actions and followers in a user's social network and other web activity such as online conversations in blogs. The present invention may allow users to state their goals within a concept such that the system can apply more specific and personalized intelligence for that user. Example goals offered by a user can include marketing, PR, new relevant content sources, new relevant people, competitive research, or product research. For example, if a user selects marketing as a goal, embodiments of the invention can predict and recommend blogs where the user can engage early in blogs with like-minded web participants such that user can increase awareness of their product or website. In this example, the embodiments of the invention can highlight web conversations versus other type of content that would be relevant on a pure keyword index basis, but would not be relevant for purposes of active online engagement. In an exemplary embodiment, this bundled information can be available via an API.

In an exemplary embodiment, the invention can include a web or mobile application that allows users to personalize and access their bundled activity and event streams. For example, the application can offer users a social graphing of topics based on user activity on the web. Embodiments of the invention can provide users an option of viewing intelligently bundled streams or the full non-bundled, but indexed, stream. This application can offer additional information such as trending concepts within a concept or trending concepts generally. In an exemplary embodiment, the application can also allow users to login to pull in filtered content from their private databases and accounts that include, but are not limited to, their existing social networks, email accounts, and organizational internal databases. In an exemplary embodiment, the invention can apply its Web Activity Indexing and Ticker creation approach to the user's private or publicly available data so that the user can have a single view of public and private information. Further, embodiments of the invention can allow users to only view their private information. Lastly, embodiments of the invention can allow users to share their activity streams, consisting of either public or private content, with other users for collaboration purposes. For example, two business owners can share a common stream of filtered web content including their public and private data so they have a single view and an application where they can discuss the filtered content.

Embodiments of the invention can provide a software implementation, cloud implementation, or appliance that allows businesses to maintain an instance on their own servers, either behind their firewalls for security purposes or in a cloud computing implementation. For example, organizations can apply public Web Activity indexing techniques to their own internal data in a secure environment. This implementation can also enable organizations and users within organizations to create proprietary Tickers or schemas, existing and new, which can be used solely by the organization, including its customers and vendors, or be made available publicly. In addition, the invention can enable a closed feedback loop where the indexing algorithms are unique to that organization's user base.

Embodiments of the invention can contain an event routing subsystem to distribute Web Events in a scalable manner. For example, the routing subsystem can leverage a publish and subscribe framework to scalably route Web Events to subscribers. Embodiments of the invention can support a number of protocols, including but not limited to, a proprietary protocol, XMPP protocol, AMQP protocol, Pubsubhub protocol, and RSS Cloud protocol. The data can also be available via an HTTP request using a non-publish and subscribe, or polling, protocol. Embodiments of the invention can support an API for each protocol it supports.

In an exemplary embodiment, the invention can support wildcards to allow programmers to access new concepts in general or within specific concepts.

Embodiments of the invention can contain an event routing rules-based filter subsystem. For example, the user can define specific rules when data is routed to them. Example rules include, but are not limited to, web activity levels for a concept or generally, trending web activity levels for a concept or generally, participation by a user in general or around a topic, specific keywords occurring with a concept, content produced on a website or by an author, any item related to discovery, and any intelligence based on the present invention's bundling techniques. The present invention can also contain rules-based optimization techniques for pushing data to a large number of subscribers and optimizing for the large number of rules.

Embodiments of the invention can support implicit routing based on information, including but not limited to, user's social graph, user's profile, public information on a user or organization in Wikipedia, for example, and any Web Activity by user, organization, or user's and organization's network.

Embodiments of the invention can include an app store for developers to sell, license, or earn advertising revenue via applications that utilize the data of the present invention and any other private data the developer owns.

### BRIEF DESCRIPTION OF THE DRAWINGS

FIG. 1 is a flow chart according to an exemplary embodiment of the invention;

FIG. 2 is a flow chart according to an exemplary embodiment of the invention;

FIG. 3 is an exemplary list of types of bundled activity and events according to embodiments of the invention;

FIG. 4 illustrates an exemplary data model according to embodiments of the invention; and

FIG. 5 is a flow chart according to an exemplary embodiment of the invention.

### DETAILED DESCRIPTION OF THE PREFERRED EMBODIMENTS

Although the following detailed description includes many specifics for the purposes of illustration, there are many variations and alterations to the following details within the scope of the invention. The following exemplary embodiments of the invention are set forth without any loss of generality to, and without imposing limitations upon, the claimed invention.

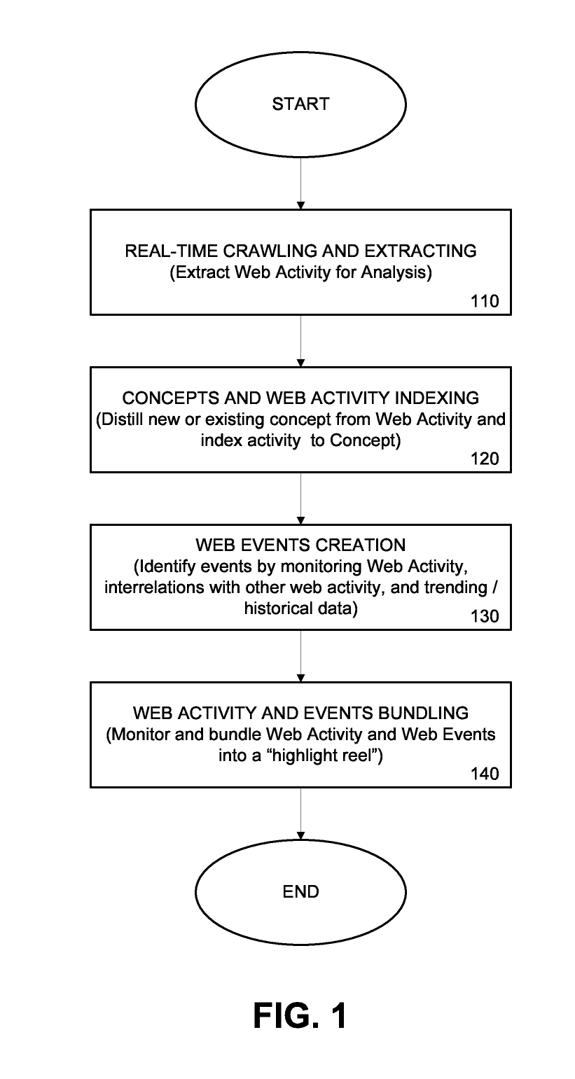

The amount of web activity, human actions, APIs, API calls, and data has increased dramatically in the past years. The ability for individuals and enterprises to manage and curate this vast information has become nearly impossible. FIG. 1 is a flow chart according to an exemplary embodiment of the invention. As shown in FIG. 1, Web Activity can be converted into manageable events (Web Events) within an event-driven architecture. The importance of achieving this within an event-driven architecture is due to the transformation of the web into an ecosystem that is more real-time and dynamic, much in the same way the stock market is, and the need for curation and determining relevance in a timely manner.

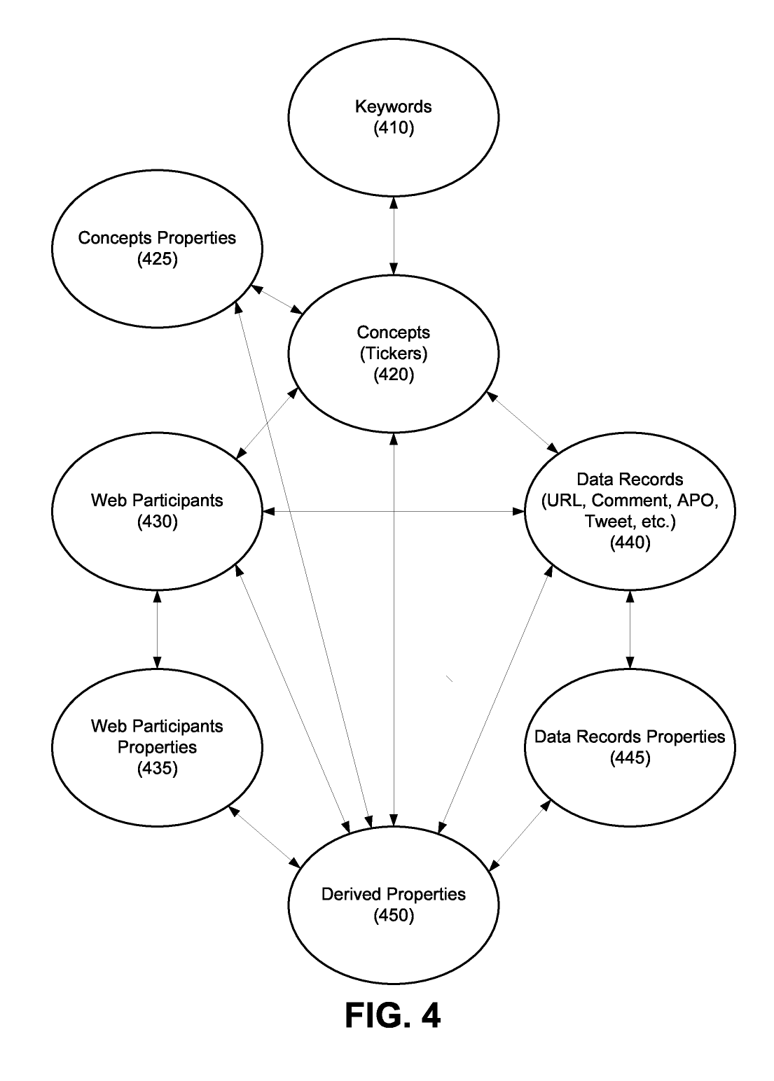

As shown in FIG. 1, at a step 110 Web Activity can be parsed. Web Activity can be brought in by a method such as a feed, API, or crawling. At a step 120, the Web Activity can be indexed for concepts (new or existing). If the concept is identified as new, a new concept can be created. The Web Activity can be indexed into a proprietary data model, such as the exemplary data model illustrated in FIG. 4. A process can be applied at a step 130 to identify the Web Events from this specific Web Activity. The Web Events can relate specifically to the new Web Event but can also relate to past and future Web Activity, and the interrelations derived from the invention.

At a step 140, Web Activity and Web Events can be intelligently bundled, taking into account historical and other recent Web Activity, and can be correlated, to create an intelligent and proprietary web activity stream. The stream can makes it easy for users to capture relationships and activity around content, people, and topics of interest. In exemplary embodiments, the results can be recommendations around people and content, suggestions around new related concepts, discovery, and predictions.

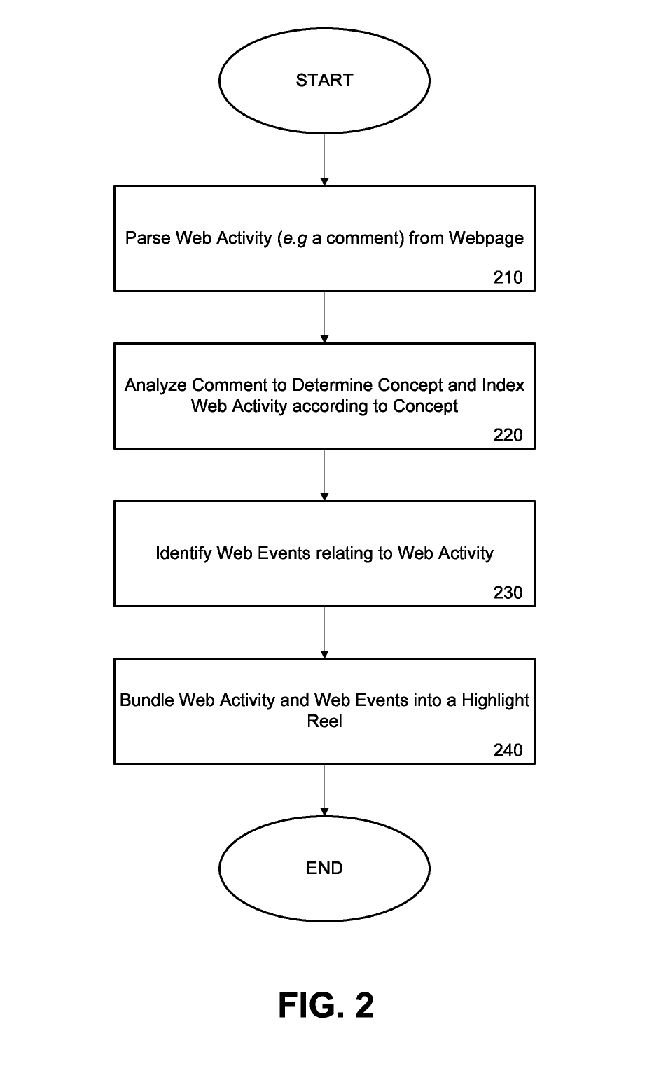

FIG. 2 is a flow chart according to an exemplary embodiment of the invention. As shown in FIG. 2, at a step 210 Web Activity such as comment from a user “Web Participant Z” can be crawled and parsed. At a step 220 the Web Activity can be analyzed to distill a concept “Concept Y” from the Web Activity. The Web Activity, in this case a comment, can be indexed to this concept and stored in a data model (e.g. FIG. 4) to capture all the information and relationships. At a step 230, Web Events can be identified from the Web Activity. In the case of a comment on a website, the Web Events can be, for example:

Type of Web Activity (i.e., a comment) in Concept Y;

Web Participant Z participated in Concept Y;

Web Participant Z is a new participant in Concept Y;

Timestamp of comment in Concept Y;

Positive sentiment of comment in Concept Y;

Webpage X activity and comments trending up; and

Interrelations between Web Participant Z, Webpage X, sentiment, Concept Y, etc. Web Activity can implicate multiple exemplary events that occurred on the web that can be stored, monitored, and analyzed relative to other Web Events.

At a step 240, the Web Activity and Web Events can be analyzed and bundled to form a Highlight Reel or cliff notes type view of the web. The bundle can be formed around topics of interest. In the exemplary embodiment illustrated in FIG. 2, four bundled events can be created that allow the user to see how the Web Activity (i.e., comment) relates to other time-sensitive activity and insights into what is occurring in their area of interest.

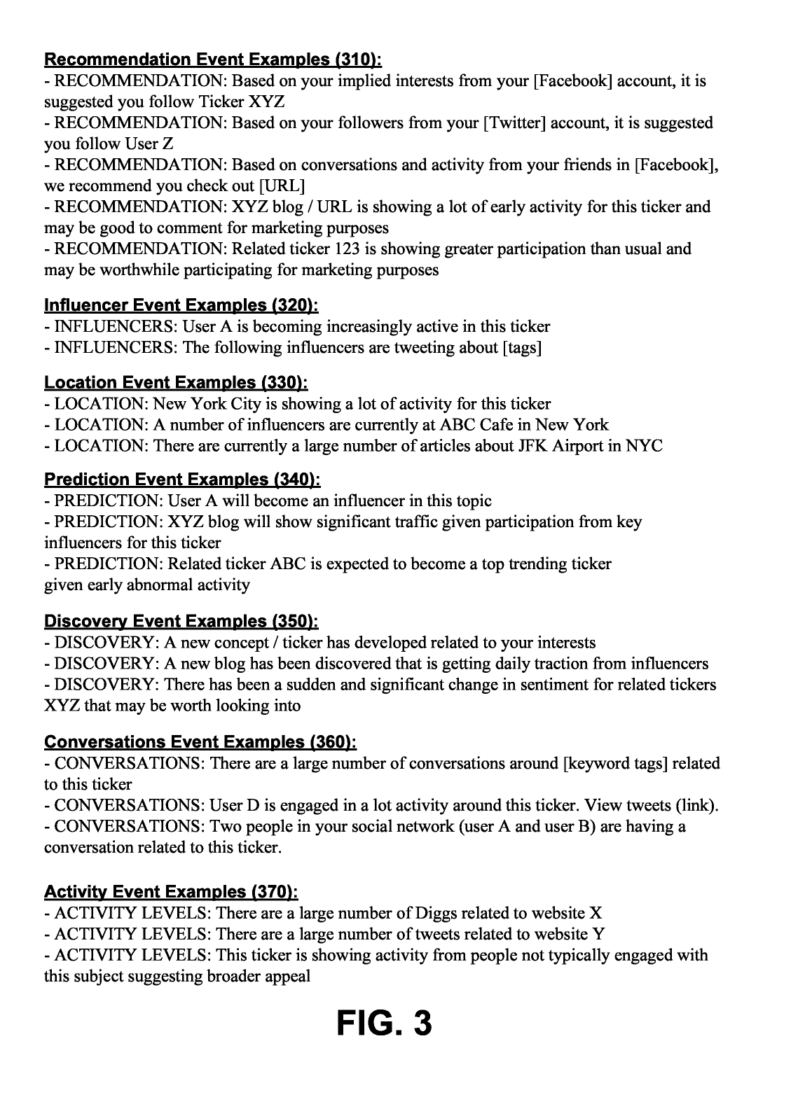

FIG. 3 is an exemplary list of types of bundled activity and events according to embodiments of the invention. Bundled activities and events can be difficult to obtain using current implementations of search engines and social networks, or a combination of the two. By highlighting unique relationships between people, content, concepts, activity levels, recorded properties, and derived properties, users can have a unique, compelling, and valuable perspective into the web. It should be noted that this is just one example of what can be done with the Web Events and indexed Web Activity.

Exemplary Recommendation Events 310 include:
RECOMMENDATION: Based on your implied interests from your [Facebook] account, it is suggested you follow Ticker XYZ;
RECOMMENDATION: Based on your followers from your [Twitter] account, it is suggested you follow User Z;
RECOMMENDATION: Based on conversations and activity from your friends in [Facebook], we recommend you check out [URL];
RECOMMENDATION: XYZ blog/URL is showing a lot of early activity for this ticker and may be good to comment for marketing purposes; and
RECOMMENDATION: Related ticker 123 is showing greater participation than usual and may be worthwhile participating for marketing purposes.

Exemplary Influencer Events 320 include:
INFLUENCERS: User A is becoming increasingly active in this ticker; and
INFLUENCERS: The following influencers are tweeting about [tags].

Exemplary Location Events 330 include:
LOCATION: New York City is showing a lot of activity for this ticker;
LOCATION: A number of influencers are currently at ABC Cafe in New York; and
LOCATION: There are currently a large number of articles about JFK Airport in NYC.

Exemplary Prediction Events 340 include:
PREDICTION: User A will become an influencer in this topic;
PREDICTION: XYZ blog will show significant traffic given participation from key influencers for this ticker; and
PREDICTION: Related ticker ABC is expected to become a top trending ticker given early abnormal activity.

Exemplary Discovery Events 350 include:
DISCOVERY: A new concept/ticker has developed related to your interests;
DISCOVERY: A new blog has been discovered that is getting daily traction from influencers; and
DISCOVERY: There has been a sudden and significant change in sentiment for related tickers XYZ that may be worth looking into.

Exemplary Conversations Events 360 include:
CONVERSATIONS: There are a large number of conversations around [keyword tags] related to this ticker;
CONVERSATIONS: User D is engaged in a lot activity around this ticker. View tweets (link); and
CONVERSATIONS: Two people in your social network (user A and user B) are having a conversation related to this ticker.

Exemplary Activity Events 370 include:
ACTIVITY LEVELS: There are a large number of Diggs related to website X;
ACTIVITY LEVELS: There are a large number of tweets related to website Y; and
ACTIVITY LEVELS: This ticker is showing activity from people not typically engaged with this subject suggesting broader appeal.

FIG. 4 illustrates an exemplary data model according to embodiments of the invention. As shown in FIG. 4, the exemplary data model can capture and enable the mapping of interrelationships between keywords 410, Concepts 420, identified properties of Concepts 425, Web Participants 430, identified properties of Web Participants 435, Data Records 440 (e.g. URLs, tweets, weibos, messages, chats, comments, APIs or API calls, emails, data files, phone calls, audio, video, or any future type of data record that becomes available, identified properties of Data Records), and Derived Properties 450 (e.g. internally monitored Web Events). This unique mapping of relationships allows for unique analysis, especially when processed within an events-driven architecture.

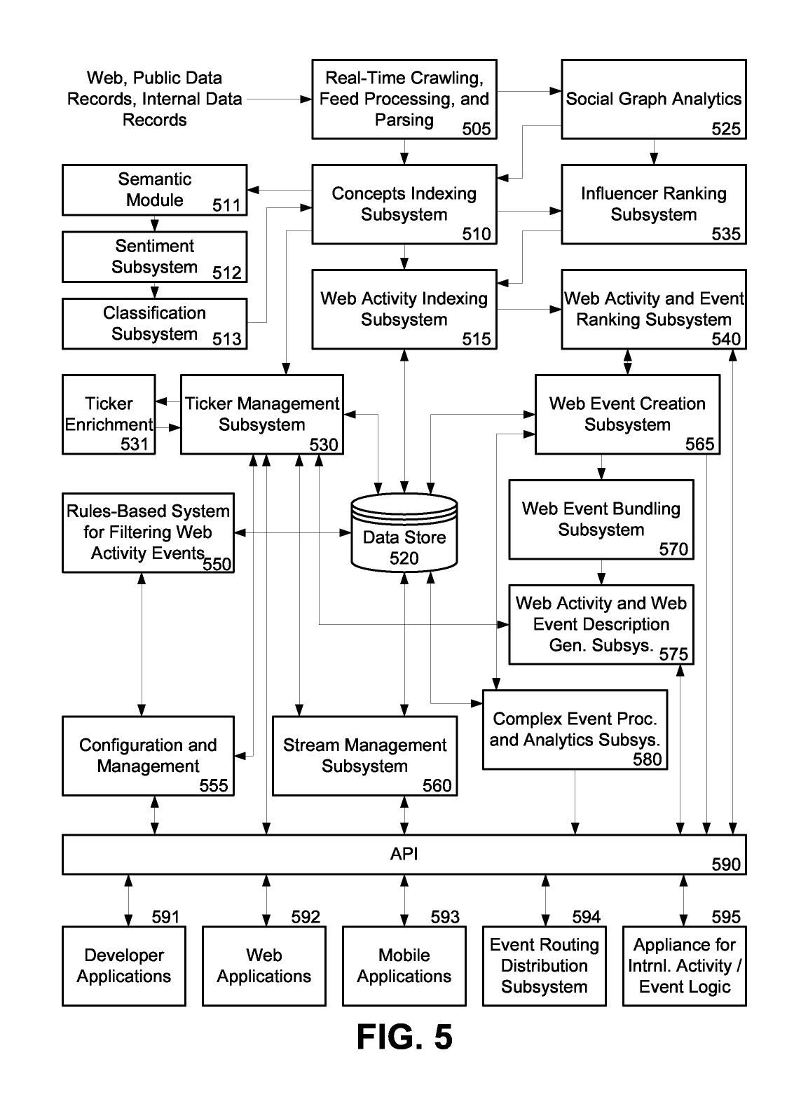

FIG. 5 is a flow chart according to an exemplary embodiment of the invention. As shown in FIG. 5, Web Activity can originate via feed processing, crawling, API, or other method and be processed by the real-time crawling, feed processing, and parsing module 505 (“crawler component”). The Web Activity can be parsed and passed to the Concepts Indexing subsystem 510 and can be passed optionally to the Social Graph Analytics subsystem 525, described below. Optionally, crawler component 505 can also include a monitoring component (not shown) to monitor the update of content. The crawler component 505 can schedule crawling activities at certain frequencies, or certain time, or when certain events occur. The concepts indexing subsystem 510 can index Web Activity by applying semantic, clustering, and fuzzy matching techniques to extract topics. These topics can be self-organized to reflect changes in online content as opposed to a top-down driven taxonomy, although either mechanism can be utilized by the invention. Examples of a concept can be “swine flu”, “real time search”, “Barack Obama”, and “Microsoft Yahoo acquisition”. The number of words in a topic can be unlimited.

Web Activity can be further analyzed by a Semantic Module 511 that takes into account synonyms and multiple meanings for words. The benefit of such a process is, unlike keywords, to allow a Concept to capture multiple meanings and therefore better reflect its corresponding Web Activity. As an analogy, if a stock ticker did not account for news related to Microsoft, MSFT, Microsoft Corporation, Micro-soft, etc. then the stock ticker would have less meaning for users to monitor it since there could be significant loss of information.

The Web Activity can be analyzed by the Sentiment Subsystem 512 for being positive or negative or neutral sentiment. This can provide valuable event information for the invention both alone and in aggregate with other Web Activity sentiment indexed to a Concept. The Web Activity can be optionally analyzed by the Classification Subsystem 513. The Classification Subsystem 513 can analyze the authority of the Web Activity to determine if it is spam, highly authoritative, or somewhere in between. The Classification Subsystem 513 can also categorize the content of the Web Activity based on different taxonomies. Such taxnomies include, but are not limited to, Sports, Politics, Entertainment, Games, and Health etc, Or News, Blogs, Microblogs, Image, Video, and Audio etc, Or English, Spanish, Chinese, and French etc for language classification, Or Novelty and Old information etc., Or Porn and Non-Porn etc., Or the buy intention etc.

The Web Activity can be passed back into the Concepts Indexing subsystem 510 by the Classification Subsystem 510 and optionally pushed to the Influence Ranking subsystem 535 to calculate the influence of the Web Activity. The Influencer Ranking subsystem 535 can combine the identified concept and Web Activity from the Concepts Indexing subsystem 510 with analysis from the Social Graph Analytics subsystem 525. The Social Graph Analytics subsystem 525 can identify the Web Participant(s) within the Web Activity and can analyze implicit and explicit social graph relationships. For example, this Social Graph Analytics subsystem 525 can determine implicit relationships based on web participants commenting to each other within a blog, explicit relationships and communications in social networks, and changes in relationships from social networks.

The Social Graph Analytics subsystem 525 can pass information to the Concepts Indexing subsystem 510 and the Influencer Ranking subsystem 535. The Influencer Ranking subsystem 535 can build a social graph for each concept. The Influencer Ranking subsystem 535 can identify which web participants are active or moderately involved around a concept. The Influencer Ranking subsystem 535 can monitor changes of web participants' activity within a concept over time to identify which web participants are becoming influential and which web participants are becoming less influential. This Influencer Ranking subsystem 535 can track the path of information across web participants within a concept as well as the method of how information is passed (comment, tweet, etc.), while taking into account the time it takes for a specific concept or content to spread.

A unique scoring methodology can be applied as content is passed from one web participant to another. This score can be applied to both web participants and the content itself. For example, if content is passed quickly among influencers, this can have a very high score and likely will be very relevant and important to web participants outside. In this case, the embodiments of the invention can notify web participants of the existence of relevant information. If an influencer passes content to a less influential person, the influence of the less influential person is increased to account that this person now has a higher probability of influential information. Finally, the path of information can be stored and measured for relevance such that if a similar path occurs in the future, then there is a high likelihood that the information will be relevant. This relevancy determination is a common technique used in forecasting weather, storms, and hurricanes. Applying probabilistic analysis to historical data can facilitate prediction and forecast of future events.

The Web Activity Indexing subsystem 515 can combine data from the Concepts Indexing subsystem 510 and Influencer Ranking subsystem 535 and normalizes the data into a Data Store 520. The Data Store 520 can reflect, for example, the data model illustrated in FIG. 4.

Simultaneously with the Web Activity Indexing process occurring in the Web Activity Indexing subsystem 515, the Web Activity can be passed from the Concepts Indexing subsystem 510 to the Ticker Management subsystem 530. The Ticker Management subsystem 530 can create Tickers (equivalent to labels or programmatic hashtags) to reflect the concepts. If a new concept is identified, the Ticker Management subsystem 530 can create a new Ticker to reflect this concept. The Ticker Management subsystem 530 can push out suggested Tickers to users to provide a powerful tool for discovery. For example, if there is new relevant Ticker highly related to a concept a user is following, this the Ticker Management subsystem 530 can suggest that the user also look at the new Ticker. The Ticker can be passed to the Ticker Enrichment subsystem 531 for enrichment.

The Ticker Enrichment subsystem 531 can use a proprietary knowledge base and third party data sources including, but not limited to, human-curated sources such as Wikipedia and Freebase, structured data sources such as Wolfram, and user-defined metadata where users can create private and public content classes and categories. This provides for better categorization of content within a Ticker for users' subscriptions. For example, bluejay may be a bird and the name of a sports team. Using enrichment, the invention could separate this out such that there are separate categories for each. There is also a user-defined case where users can provide keyword tags and “Web Activity Tags” to instruct embodiments of the invention how to index Web Activity. The user-defined metadata can be used privately, within an enterprise for example, or be made available publicly. It should be noted that in certain cases, a Ticker can be enriched such that it equates to a value. For example, a Ticker may reflect the population of a city and this would equal a number.

Data enriched by the Ticker Enrichment subsystem 531 can be passed back to the Ticker Management subsystem 530 and subsequently can be stored in the Data Store 520, pushed to the API 590, pushed to the Web Stream Management subsystem 560, pushed to Configuration and Management subsystem 555, and/or pushed to Web Activity & Event Description and Generation subsystem 575. Note that lines used to represent data flow are two-way in each case to reflect user-defined data and subscriptions to Tickers.

Once the data has been stored in the Data Store 520 and Tickers have been created that allows for subscription to this data, numerous use cases exist based on the requirements of users and type of data. One or all of the use cases may be implemented by embodiments of the invention.

In an exemplary embodiment, the full web activity stream, indexed to a Concept with a Ticker label, can be pushed to users or businesses via the Stream Management Subsystem 560. The Stream Management Subsystem 560 can manage stream subscriptions and filter rules from the users and pushes data to the API 590. In other embodiments, developers can subscribe to data streams via a Configuration and Management subsystem 555. The Configuration and Management subsystem 555 can include a graphical user interface and a Rules-Based Filtering subsystem 550 for filtering Web Activity based on rules.

Exemplary embodiments of the invention can pass data from the Data Store 520 to the Web Events Creation subsystem 565. The Web Events Creation subsystem 565 can transform basic Web Activity into unique events that can be monitored. The Web Events can be i) stored in the Data Store 520, ii) passed to the Web Activity and Event Ranking subsystem 540 where Web Activity and Events are ranked and then passed back to Web Events Creation subsystem 565, or iii) bundled and analyzed by the Web Event Bundling subsystem 570, then generated with a description by the Web Activity and Event Description Generation subsystem 575. The Web Event Bundling subsystem 570 and the Web Activity and Event Description Generation subsystem 575 can generate the exemplary bundled activity and events listed in FIG. 3. The Web Activity and Event Description Generation subsystem 575 can push bundled events to the API 590. This is a two-way flow to account for user feedback and requests.

In an exemplary embodiment, Web Events created by the Web Event Creation subsystem 565 and stored in the Data Store 520 can be passed to the Complex Event Processing and Analytics subsystem 580 (“CEP”). Because the embodiments of the invention can transform basic Web Activity into Web Events, event-driven analytics can be applied to analyze the events. This subsystem may employ both computation-oriented CEP and detection-oriented CEP. The CEP subsystem 580 can employ techniques such as event correlation and abstraction, detection of complex patterns of many event hierarchies, and relationships between events such as causality, membership, and timing, and event-driven processes. The CEP subsystem 580 can infer and predict relationships, events, relevance, and future Web Activity.

Where traditional search engines measure wisdom of the crowds by measuring popularity of web pages, embodiments of the invention can predict wisdom before the crowd by creating and analyzing events. An analogy would be the stock market where stock prices reflects wisdom of the crowd (as a function of efficient market theories) but where algorithmic trading considers patterns and correlation of events to predict high probabilistic movement in stocks and markets. By converting Web Activity into a framework described by events, which can be monitored and analyzed, the invention can transform the web from a content paradigm to a quantifiable events paradigm,

The CEP subsystem 580 can push data to the API 590, back to the Data Store 520, or to the Web Events Creation subsystem 565 where the new CEP events can be taken into account.

At the API 590, data can be accessed or pushed into a developer framework 591, web applications 592, mobile applications 593, an event-routing distribution framework 594, or into an appliance or instance in a cloud 595 such that an enterprise or business can have access to any of the components described in the invention for their own use and customization of data.

Examples of web applications 592 and mobile applications 593 include, but are not limited to, a web activity stream that provides highlights of the web around concepts or a directory application that shows how the relationships of web participants, concepts, content, and data records (URLs) all interrelate and change over time.

It will be apparent to those skilled in the art that various modifications and variations can be made in the System and Method for Indexing, Ranking, and Analyzing Web Activity within an Event Driven Architecture of embodiments of the invention without departing from the spirit or scope of the invention. Thus, it is intended that embodiments of the invention cover the modifications and variations of this invention provided they come within the scope of the appended claims and their equivalents.

What is claimed is:

1. A system for organizing a web activity comprising:
a parsing module for receiving the web activity;
a concept indexing module for indexing the web activity according to a plurality of concepts in a concept index;
a web event creation module for generating a plurality of web events from the web activity;
a web activity indexing module for indexing the web activity according to the plurality of web events in a web event index;
a ticker management module for generating a plurality of tickers each respectively associated with at least one of the plurality of concepts; and
a database for storing the concept index, the web event index, and the plurality of tickers.

2. The system of claim 1 further comprising a concept creation module for generating the plurality of concepts from the web activity;

3. The system of claim 2 wherein the concept creation module comprises:
a semantic module;
a sentiment module; and
a classification module.

4. The system of claim 1, further comprising a social graph analytics module for analyzing a social network.

5. The system of claim 1, further comprising an influencer ranking module for determining the influence of a creator of the web activity.

6. The system of claim 1, further comprising a ticker enrichment module.

7. The system of claim 1, further comprising:
a web event bundling module; and
a web activity and web event description generation module.

8. The system of claim 1, further comprising an API for interfacing with an external application.

9. A method for organizing a web activity comprising:
receiving the web activity;
parsing the web activity;
indexing the web activity according to a plurality of concepts in a concept index;
generating a plurality of web events from the web activity;
indexing the web activity according to the plurality of web events in a web event index;
generating a plurality of tickers each respectively associated with at least one of the plurality of concepts; and
storing the concept index, the web event index, and the plurality of tickers in a database.

10. The method of claim 9 further comprising generating a plurality of concepts from the web activity.

11. The method of claim 10 wherein the generating the plurality of concepts from the web activity comprises:
applying a semantic analysis to the web activity;
determining a sentiment of the web activity;
determining an authoritiveness of the web activity; and
determining a category of the web activity based on a specified taxonomy.

12. The method of claim 9, further comprising:
identifying a first web participant within the web activity; and
determining a relationship between the first web participant and a second within a social network; and
generating at least one the plurality of web events according to the relationship.

13. The method of claim 9, further comprising determining an influence of a creator of the web activity.

14. The method of claim 9, further comprising enriching one of the plurality of tickers.

15. The method of claim 9, further comprising:
bundling a first and second web event of the plurality of web events; and
generating a description of the web activity, the first web event, and the second web event.

16. The method of claim 9, further comprising interfacing with an API.

17. A system for organizing web activity comprising:
a monitoring module for detecting a web activity;
a parsing module for receiving the web activity;
a concept creation module for generating a plurality of concepts from the web activity;
a concept indexing module for indexing the web activity according to the plurality of concepts in a concept index;
a web event creation module for generating a plurality of web events from the web activity;
a web activity indexing module for indexing the web activity according to the plurality of web events in a web event index;
a ticker management module for generating a plurality of tickers each respectively associated with at least one of the plurality of concepts; and
a database for storing the concept index, the web event index, and the plurality of tickers.

18. A method for organizing web activity comprising:
detecting a web activity;
parsing the web activity;
generating a plurality of concepts from the web activity;
indexing the web activity according to the plurality of concepts in a concept index;
generating a plurality of web events from the web activity;
indexing the web activity according to the plurality of web events in a web event index;
generating a plurality of tickers each respectively associated with at least one of the plurality of concepts; and
storing the concept index, the web event index, and the plurality of tickers in a database.
